(19) United States
(12) Patent Application Publication
(10) Pub. No.: US 2009/0224489 A1
(43) Pub. Date: Sep. 10, 2009

(54) Oil seal

(75) Inventor: Cheng Feng Lin, Taipei City (TW)

Correspondence Address: BACON & THOMAS, PLLC, 625 SLATERS LANE, FOURTH FLOOR, ALEXANDRIA, VA, 22314-1176, US

(73) Assignee: UNIPOINT ELECTRIC MFG. CO., LTD., Taipei City (TW)

(21) Appl. No.: 12/073,600

(22) Filed: Mar. 7, 2008

(51) Int. Cl. F16L 17/035

(52) U.S. Cl. 277/615

(57) ABSTRACT

An oil seal for preventing oil leakage and adapted to fit a shaft comprises an annular casing, a first seal component, a second seal component, a first seal lip and a second seal lip. The annular casing has a hole provided for the shaft passing through the annular casing. The first seal component is mounted on the annular casing. The second seal component is mounted on the annular casing and used for preventing a lubricating oil leaking from the first seal component. The first seal lip is disposed on the first side of the annular casing and used for preventing the lubricating oil leaking from the first side of the annular casing. The second seal lip is disposed on second side the annular casing, the second side is opposite to the first side, and the second seal lip used for preventing the dust from entering the oil seal.

### FIELD OF THE INVENTION

The present invention relates to an oil seal used in the oil hydraulic mechanics, and more particularly to an oil seal which has at least two seal components and two seal lips.

### BACKGROUND OF THE INVENTION

FIG. 1 illustrates a section view of the conventional oil seal. The oil seal 1 comprises an annular casing 11, a seal lip 12 and a seal component 13.

The annular casing 11 includes an outer surface of wall 111 and a spindle hole formed at the center of the annular casing 11. The spindle hole of annular casing 11 is provided for a shaft 2 passing through the annular casing 11. The annular casing 11 is operable to mount the seal component 13.

The seal lip 12 is extended circularly from one side of the annular casing 11 towards the axial direction of the shaft 2. The seal lip 12 firmly encapsulates the annular casing 11 and the shaft 2 for preventing the lubricating oil 20 leaking from the oil seal 1.

The seal component 13 is mounted on the annular casing 11 and extended from the annular casing 11 towards the axial direction of the shaft 2. A container chamber 110 is formed by the annular casing 11, the seal component 13 and the shaft 2, and the container chamber 110 can contain a lubricating oil 20 inside the oil seal 1.

When the shaft 2 passes through the spindle hole of the annular casing 11 and moved along the axial direction of the shaft 2 back and forth, because the shaft 2 is encapsulated firmly by the seal lip 12 and the seal component 13, the lubricating oil 20 can be remained at the container chamber 110 and not leaking out of the oil seal 1.

When the seal component 13 is damaged and the sealing ability decreased due to usage for a long time, the lubricating oil 20 adhered the shaft 2 may leak from the seal component 13 to the outside of the oil seal 1, and it results in decreasing of the efficiency of the oil seal 1 and lake of the lubricating oil 20 on the shaft 2.

### SUMMARY OF THE INVENTION

Therefore, it is one of objectives of the present invention to provide an oil seal which prevents the leakage of the lubricating oil more effectively and has improved endurability.

The present invention provides an oil seal for preventing oil leakage and adapted to fit a shaft. The oil seal comprises an annular casing, a first seal component, a second seal component, a first seal lip and a second seal lip. The annular casing has a spindle hole at the center for the shaft passing through the annular casing. The first seal component is mounted on the annular casing. The second seal component is mounted on the annular casing and used for preventing a lubricating oil leaking from the first seal component. The first seal lip is disposed on the first side of the annular casing and used for preventing the lubricating oil leaking from the first side of the annular casing. The second seal lip is disposed on the second side of the annular casing for preventing the dust from entering the oil seal. The second side is opposite to the first side.

As described above, when the first seal component or first lip can not firmly encapsulates the shaft for preventing the lubricating oil from leaking due to decreasing of sealing ability, the second seal component can further exert the sealing ability to prevent the lubricating oil leaking out of the oil seal.

### BRIEF DESCRIPTION OF THE DRAWINGS

The subject matter regarded as the invention is particularly pointed out and distinctly claimed in the concluding portion of the specification. The invention together with features and advantages thereof may best be understood by reference to the following detailed description with the accompanying drawings in which:

FIG. 1 illustrates a sectional view of the conventional oil seal;

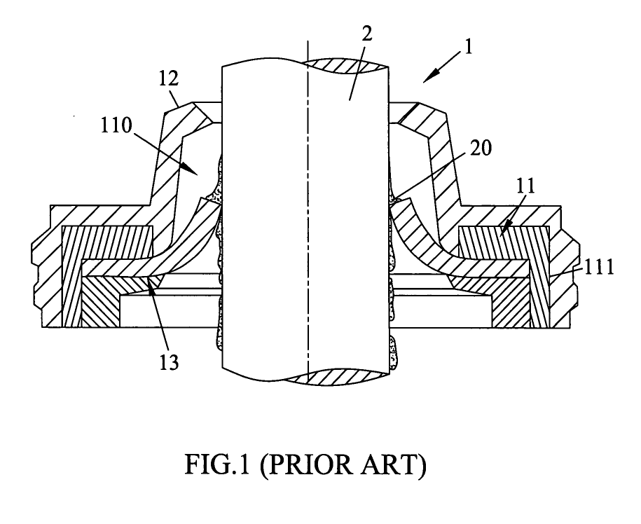

FIG. 2 illustrates a section view of the first embodiment of the oil seal in accordance with the present invention;

FIG. 3 illustrates a section view of the second embodiment of the oil seal in accordance with the present invention; and

FIG. 4 illustrates a section view of the third embodiment of the oil seal in accordance with the present invention.

### DETAILED DESCRIPTION OF THE PREFERRED EMBODIMENTS

To make it easier for our examiner to understand the present invention, the following detailed description with reference to the accompanying drawings of embodiments are given for example, but such preferred embodiment is not intend to limit the scope of the present invention. For simplicity, like numerals are used for like elements as described in the specification of the present invention.

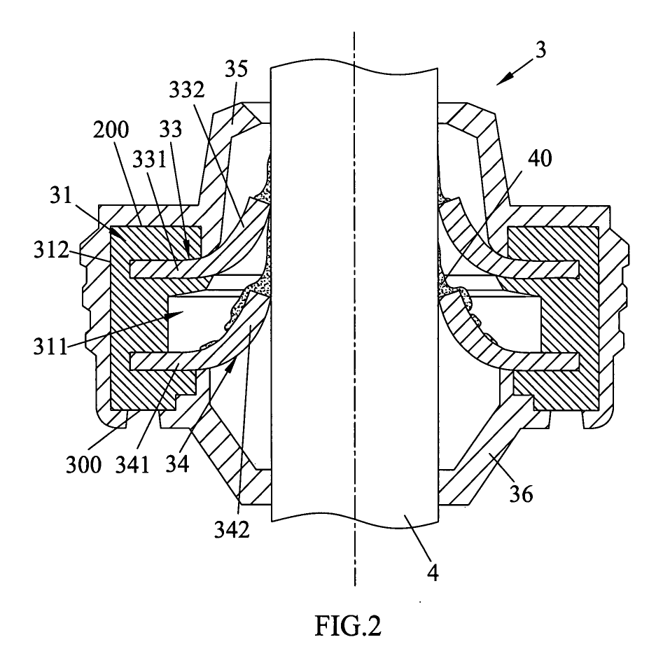

FIG. 2 illustrates a section view of the first embodiment of the oil seal in accordance with the present invention. The oil seal 3 comprises an annular casing 31, a first seal component 33, a second seal component 34, a first seal lip 35 and a second seal lip 36.

The annular casing 31 includes an outer surface of wall 312, a first side 200, a second side 300 and a spindle hole formed at the center of the annular casing 31, wherein the second side 300 is opposite to the first side 200. The spindle hole of annular casing 31 is provided for a shaft 4 passing through the annular casing 31. The annular casing 31 is operable to mount the first seal component 33 and the second seal component 34. Preferably, the annular casing 31 can be a metal cylinder, and the annular casing 31 can further comprise multiple constraint components used for constraining the first seal component 33 and the second seal component 34. The first seal component 33 and the second seal component 34 can be extended to the same direction or the different direction.

The first seal lip 35 is extended circularly from the first side 200 of the annular casing 31 towards the axial direction of the shaft 4. The second seal lip 36 is extended circularly from the second side 300 of the annular casing 31 towards the axial direction of the shaft 4. The first seal lip 35 is used for preventing the lubricating oil 40 leaking from the oil seal 3, and the second seal lip 36 is used for preventing the dust from entering the oil seal 3. Preferably, the first seal lip 35 and the second seal lip 36 can be made from elastic material. Besides, the first seal lip 35 and the second seal lip 36 can be integrally formed if necessary.

The first seal component 33 has first fixed portion 331 and a first converged portion 332. The first fixed portion 331 is mounted into the annular casing 31, and the first converged portion 332 is extended from the first fixing portion 331 towards the axial direction of the shaft 4. The first seal component 33 is used for preventing the leakage from the lubricating oil 40. Preferably, the first seal component 33 can be made from teflon, polyurethane, polyacrylate, fluorosilicone or materials used for oil seal.

The second seal component 34 includes a second fixed portion 341 and a second converged portion 342. The second fixed portion 341 is mounted into the annular casing 31, and the second converged portion 342 is extended from the second fixed portion 341 towards the axial direction of the shaft 4. The second seal component 34 is used for preventing a lubricating oil 40 leaking from the first seal component 33. A container chamber 311 is formed by the annular casing 31, a first seal component 33, a second seal component 34 and a shaft 4, and the container chamber 311 can contain a lubricating oil 40 inside the oil seal 3. Preferably, the second seal component 34 can be made from teflon, polyurethane, polyacrylate, fluorosilicone or materials use for oil seal. Preferably, the first seal component 33 and the second seal component 34 can be extended towards the same direction or different directions.

When the shaft 4 passes through the spindle hole of the annular casing 31 and moved along the axial direction of the shaft 4 back and forth, because the shaft 4 is encapsulated firmly by the first seal lip 35 and the first seal component 33, the lubricating oil 40 can be remained at the container chamber 311 and not leak out of the oil seal 3.

When the first seal component 33 is damaged and the sealing ability decreased, the lubricating oil 40 adhered to the shaft 4 may leak from first seal component 33 and moved towards the second seal component 34, the second seal component 34 can exert the sealing ability to prevent the lubricating oil 40 leaking out of the oil seal 3.

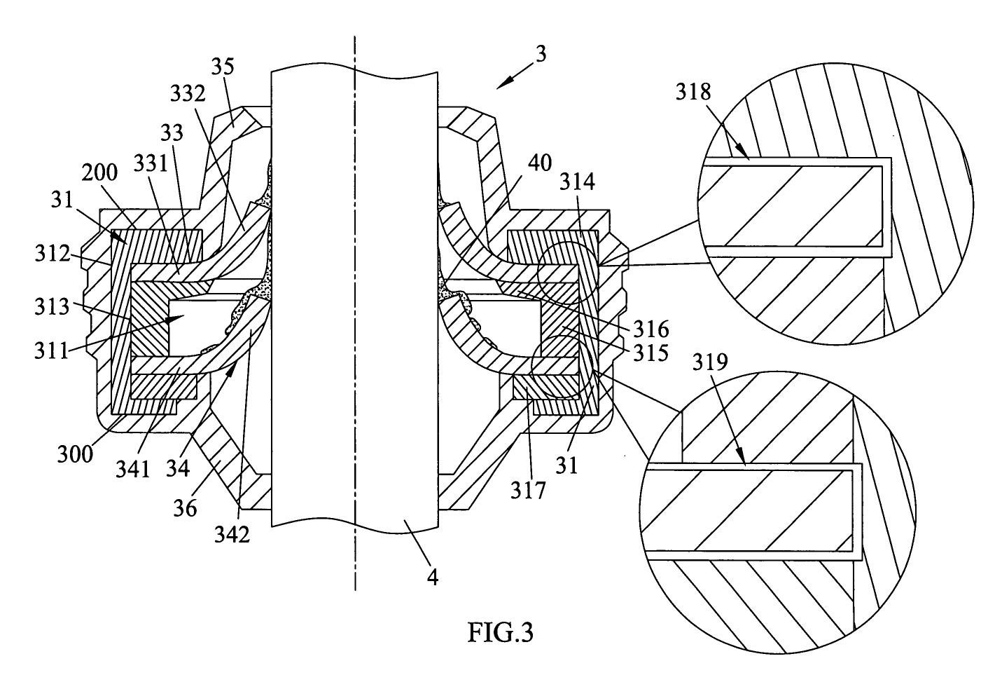

FIG. 3 illustrates a section view of the second embodiment of the oil seal in accordance with the present invention. The oil seal 3 comprises an annular casing 31, a first seal component 33, a second seal component 34, a first seal lip 35 and a second seal lip 36.

The annular casing 31 includes an outer surface of wall 312, an inner side of wall 313, a first side 200 and a second side 300, wherein the second side 300 is opposite to the first side 200. The spindle hole of the annular casing 31 is provided for a shaft 4 passing through the annular casing 31. The annular casing 31 is operable to mount the first seal component 33 and the second seal component 34. Preferably, the annular casing 31 can be a metal cylinder and the annular casing 31 can further comprise multiple constraint components used for constraining the first seal component 33 and the second seal component 34.

The annular casing 31 further includes a first constraint component 314, a second constraint component 315, a third constraint component 317, a first constraint groove 318, a second constraint groove 319, a first seal component 33 and a second seal component 34.

The first seal lip 35 is extended circularly from the first side 200 of the annular casing 31 towards the axial direction of the shaft 4. The second seal lip 36 is extended circularly from the second side 300 towards the axial direction of the shaft 4. The first seal lip 35 is used for preventing the lubricating oil 40 leaking from the oil seal 3, and the second seal lip 36 is used for preventing the dust from entering the oil seal 3. The first seal lip 35 and the second seal lip 36 are integrally formed and firmly encapsulating the annular casing 31. Preferably, the first seal lip 35 and the second seal lip 36 can be made from elastic material.

The first constraint component 314, the second constraint component 315 and the third constraint component 317 are extended circularly from the inner side of wall 313 towards the axial direction of the shaft 4. The second constraint component 315 is disposed between the first constraint component 314 and the third constraint component 317. Preferably, the first constraint component 314, the second constraint component 315 and the third constraint component 317 can be made from metal material.

The first constraint groove 318 is formed between the first constraint component 314 and the second constraint component 315, and the second constraint groove 319 is formed between the second constraint component 315 and the third constraint component 317.

The first seal component 33 has a first fixed portion 331 and a first converged portion 332. The first fixed portion 331 is inserted into the first constraint groove 318, and the first converged portion 332 is extended circularly from the first fixed portion 331 towards the shaft 4. Preferably, the first seal component 33 is made from teflon, polyurethane, polyacrylate, fluorosilicone or materials used for oil seal.

The second seal component 34 has a second fixed portion 341 and a second converged portion 342. The second fixed portion 341 is inserted into the second constraint groove 319, and the second converged portion 342 is extended circularly from the second fixed portion 341 towards the shaft 4. The first seal component 33 and the second seal component 34 are extended towards the same direction. A container chamber 311 is formed by the annular casing 31, a first seal component 33, a second seal component 34 and a shaft 4 for containing a lubricating oil 40 inside the oil seal 3. Preferably, the second seal component 34 is made from teflon, polyurethane, polyacrylate, fluorosilicone or materials used for oil seal.

The second constraint component 315 further has a press edge 316 which is extended circularly from one side of the second constraint component 315 towards the axial direction of the shaft 4. Preferably, the press edge 316 is used for enhancing the pressing ability of the second constraint component 315 for constraining the first seal component 33.

When the shaft 4 passes through the spindle hole of the annular casing 31 and moved along the axial direction of the shaft 4 back and forth, because the shaft 4 is encapsulated firmly by the first seal lip 35 and the first seal component 33, the lubricating oil 40 can be remained at the container chamber 311 and not leak out of the oil seal 3.

When the first seal component 33 is damaged and the sealing ability decreased, the lubricating oil 40 adhered to the shaft 4 may leak from first seal component 33 and moved towards the second seal component 34, the second seal component 34 can exert the sealing ability to prevent the lubricating oil 40 from leaking out of the oil seal 3.

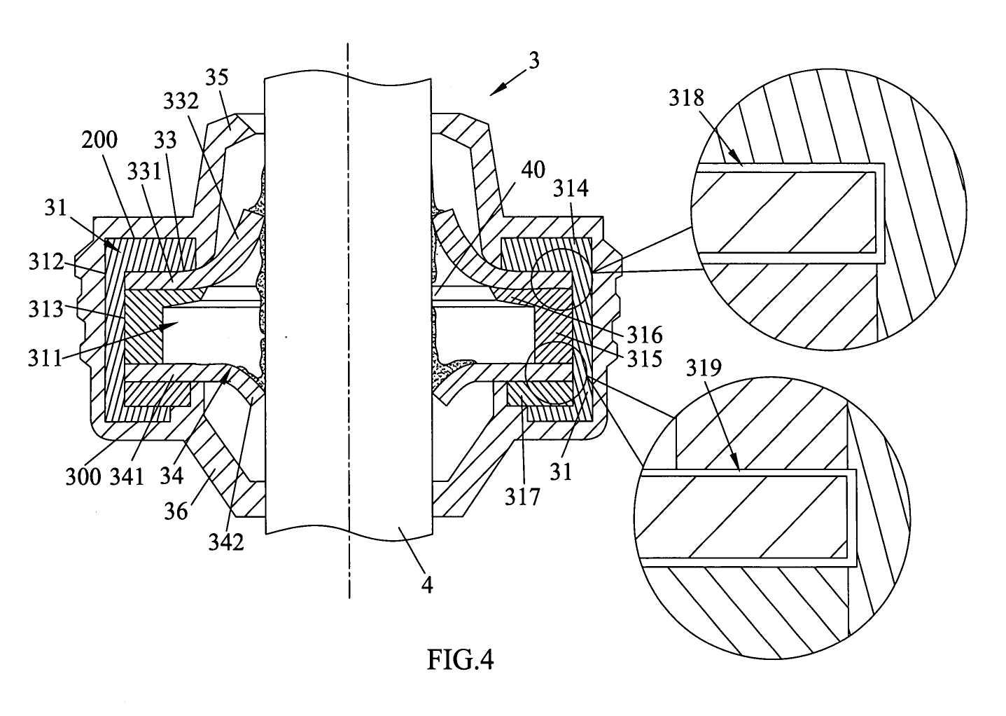

FIG. 4 illustrates a section-view of the third embodiment of the oil seal in accordance with the present invention. The oil seal 3 comprises an annular casing 31, a first seal component 33, a second seal component 34, a first seal lip 35 and a second seal lip 36. The difference between the third embodiment and second embodiment is that the first seal component 33 and the second seal component 34 are extended to different directions.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An oil seal for preventing oil leakage, said oil seal adapted to fit a shaft, and said oil seal comprising:
an annular casing, having a spindle hole at the center for providing said shaft passing through said annular casing;
a first seal component, mounted on said annular casing;
a second seal component, mounted on said annular casing, for preventing a lubricating oil leaking from said first seal component;
a first seal lip, disposed on first side of said annular casing for preventing said lubricating oil leaking from said first side of said annular casing; and
a second seal lip, disposed on second side of said annular casing, and said second side being opposite to said first side, wherein said second seal lip is for preventing the dust from entering said oil seal.

2. The oil seal of claim 1, wherein said annular casing further comprises:
a first constraint component, extended circularly from said annular casing towards an axial direction of said shaft;
a second constraint component, extended circularly from said annular casing towards said axial direction of the shaft; and
a third constraint component, extended circularly from said annular casing towards said axial direction of the shaft, and said second constraint component located between said first constraint component and said third constraint component;
wherein said first seal component is mounted between said first constraint component and said second constraint component, said second seal component is mounted between said second constraint component and said third constraint component.

3. The oil seal of claim 2, wherein said annular casing further comprises a press edge extended circularly from said second constraint component, and said press edge is used for enhancing the fixing ability for said first seal component or said second seal component.

4. The oil seal of claim 1, wherein said first seal component or said second seal component is made form teflon, polyurethane, polyacrylate, fluorosilicone or materials used for the oil seal.

5. The oil seal of claim 1, wherein said first seal lip or said second seal lip is made from elastic material.

6. The oil seal of claim 1, wherein said first seal lip or second seal encapsulates an outer surface wall of said annular casing

7. The oil seal of claim 1, wherein said first seal lip and second seal lip are integrally formed.

8. The oil seal of claim 1, wherein said first seal lip and said second seal lip can be extended towards to same direction of different directions.
